(19) United States
(12) Patent Application Publication
(10) Pub. No.: US 2007/0115288 A1
(43) Pub. Date: May 24, 2007

(54) Sprite interface and code-based functions

(75) Inventors: Dennis G. Cronin, Bellevue, WA (US); Peter T. Barrett, Palo Alto, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/285,220

(22) Filed: Nov. 22, 2005

(51) Int. Cl. G06T 15/70

(52) U.S. Cl. 345/473

(57) ABSTRACT

Sprite interface and code-based functions is described. In an embodiment, a sprite interface is implemented in managed code to provide an interface to sprite animation functions for a gaming application. A sprite application is implemented in native code to provide the sprite animation functions via the sprite interface when initiated by the gaming application. The gaming application, sprite interface, and the sprite application can be implemented in a low-end computing-based device, such as a television-based client device.

### BACKGROUND

Video game technologies have greatly advanced since the early games of the 1980's. Faster processors (CPUs), 3D rendering technologies, shaders, and high powered video cards not available two decades ago have all advanced gaming. The concept of “sprites” was introduced to allow low-powered early model personal computers and arcade games to deliver fast-paced interactive gaming. A sprite is a small graphic image that can be moved quickly around a display screen with very little hardware processing. The game “Frogger”, for example, is a classic interactive video game that utilizes sprites to animate the frogs, cars, and the other moving items that are the animated graphic images of the game.

Sprite animation was implemented in hardware chips. A Sprite image had a fixed size and could be moved around the display screen quickly by simply changing the hardware register defining a sprite's (x,y) position on the screen. Sprite-enabled hardware chips also supported auto-collision detection of sprite images, such as detecting a rocket sprite image “hitting” or intersecting a ship sprite image in a game, for example, by reading a collision mask register instead of having to perform complex intersection tests with a low-powered processors. By the 1990s, sprites were rapidly disappearing as faster processors were developed for advanced video game modeling and rendering.

### SUMMARY

This summary is provided to introduce simplified concepts of Sprite interface and code-based functions which is further described below in the Detailed Description. This summary is not intended to identify essential features of the claimed subject matter, nor is it intended for use in determining the scope of the claimed subject matter.

In an embodiment of Sprite interface and code-based functions, a sprite interface is implemented in managed code to provide an interface to sprite animation functions and tiling functions, such as for a gaming application. A sprite application and/or a tiler application are implemented in native code to provide the sprite animation and tiling functions via the sprite interface when initiated by the gaming application. The gaming application, sprite interface, sprite application, and the tiler application can be implemented in a low-end computing-based device, such as a television-based client device.

### BRIEF DESCRIPTION OF THE DRAWINGS

The same numbers are used throughout the drawings to reference like features and components.

FIG. 1 illustrates an exemplary gaming system in which embodiments of Sprite interface and code-based functions can be implemented.

FIG. 2 illustrates an example of Sprite animation and tiling functions which can be implemented with embodiments of Sprite interface and code-based functions.

FIG. 3 further illustrates the example of Sprite animation and tiling functions shown in FIG. 2 which can be implemented with embodiments of Sprite interface and code-based functions.

FIG. 4 illustrates exemplary method(s) for Sprite interface and code-based functions.

FIG. 5 illustrates various components of an exemplary client device in which embodiments of Sprite interface and code-based functions can be implemented.

### DETAILED DESCRIPTION

Sprite interface and code-based functions provides a sprite interface via which a gaming application can access the sprite animation functions of a sprite application and/or a tiler application in a low-end computing device, such as a television-based client device. A low-end television-based client device is also commonly referred to as a “thin client” due to the limited processing and graphics capabilities of the device. The variety of video games available for use on a thin client has typically been limited due to the limited processing and graphics constraints. Sprite interface and code-based functions provides that even the constrained platforms of a thin client can provide action-orientated interactive games written in managed code which, previously, could not be implemented in a thin client with limited processing power.

The sprite interface is implemented in managed code and abstracts the more processor intensive aspects of sprite-based animation which is implemented in native code to provide rendering and collision detection which can be driven from simple C# (C-Sharp) game code. By implementing a sprite application (also referred to as a sprite “engine”) in native code and exposing it to the C# managed layer in a low-end computing device runtime, older classic arcade games can be quickly ported and adapted to a television-based environment. Sprite interface and code-based functions also provides for tile-based rendering of video game background sprite images which allows for fast scrolling as a video character moves through the video game. A tiler application (also referred to as a tiler “engine”) can also be implemented in native code and can be interfaced independently of the sprite animation functions.

While aspects of the described systems and methods for Sprite interface and code-based functions can be implemented in any number of different computing systems, gaming systems, environments, and/or configurations, embodiments of Sprite interface and code-based functions are described in the context of the following exemplary system architectures.

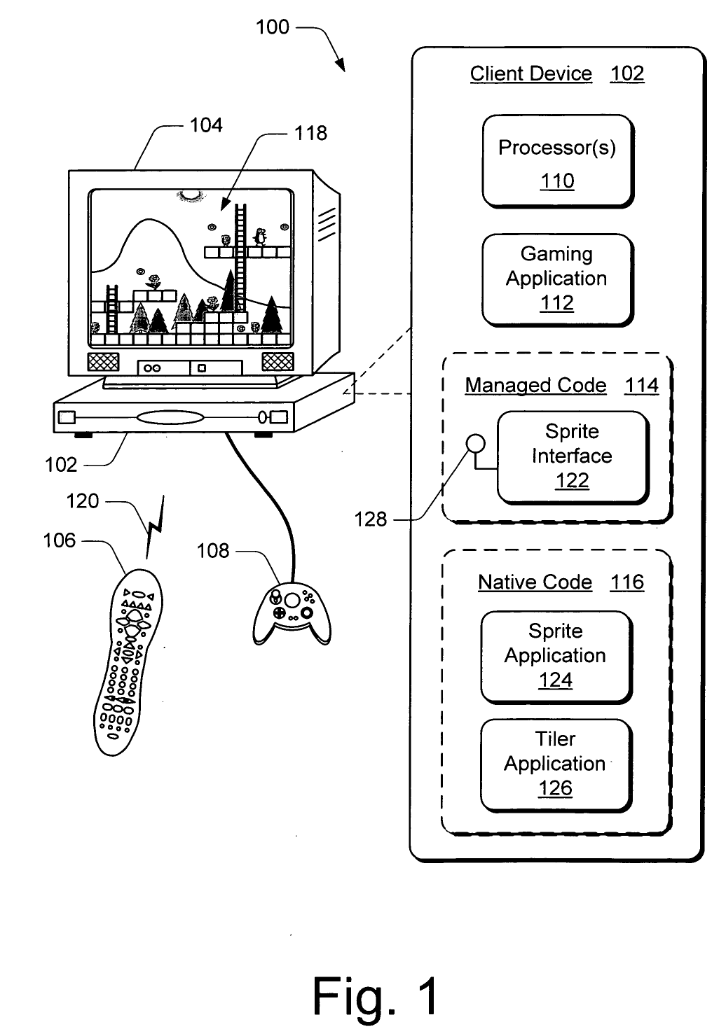

FIG. 1 illustrates an exemplary gaming system 100 in which embodiment(s) of Sprite interface and code-based functions can be implemented. The gaming system 100 is implemented in a television-based client device 102, includes a display device 104, and optionally includes a television-based remote control device 106, a gaming controller 108, and/or any other input control device such as a keyboard, joystick, and the like. The display device 104 can be any type of television, monitor, or similar television-based display system that renders audio, video, and/or image data. The client device 102 and display device 104 together are but one example of a television-based client system.

Client device 102 can be implemented in any number of embodiments, such as a set-top box, a digital video recorder (DVR) and playback system, an appliance device, a gaming device, and as any other type of client device or low-end client device that may be implemented in an entertainment and/or information system. Alternatively, embodiments of Sprite interface and code-based functions may be implemented in other low-end computing-based devices such as a cellular phone, PDA (personal digital assistant), portable gaming device, and the like.

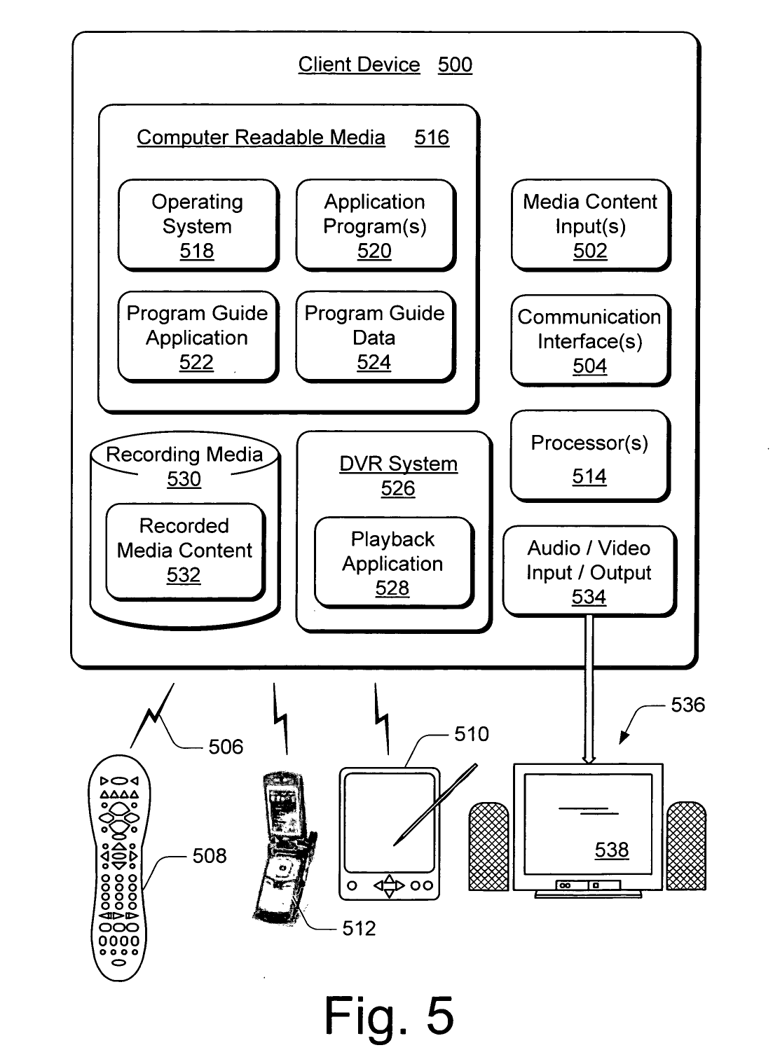

In this example, client device 102 includes one or more processor(s) 110 as well as a gaming application 112, managed code 114, and native code 116, all of which can be implemented as computer executable instructions and executed by the processor(s) 110. Additionally, client device 102 may be implemented with any number and combination of differing components as further described below with reference to the exemplary client device 500 shown in FIG. 5.

The managed code 114 is an example of code that is managed by the NET Framework Common Language Runtime (CLR) to interact between natively executing code (e.g., native code 116) and the runtime on device 102. The native code 116 is an example of computer executable instructions that are written directly in a low level language and compiled to execute on the specific processor(s) 110.

The gaming application 112 can be any type of user-interactive and/or video-based game that provides an interactive display 118 on the display device 104. A user can initiate the game for entertainment and interact with the game according to the interactive display 118 with the remote control device 106 and/or the gaming controller 108 via wired or wireless inputs 120. The remote control device 106 and/or the gaming controller 108 can include various configuration and television-specific input keys, an input keypad, and/or various user-selectable input controls to interact with the gaming application 112.

In the exemplary gaming system 100, a managed sprite interface 122 is implemented in managed code 114, and a sprite application 124 and/or tiler application 126 are implemented in the native code 116. The sprite application 124 may also be referred to as a sprite “engine” to implement sprite animation functionality for the gaming application 112. Similarly, the tiler application 126 may also be referred to as a tiler “engine” to implement tiling functionality, such as background sprite images for the interactive display 118 on display device 104. Sprite interface and code-based functions abstracts the conventional hardware graphics chip previously used for sprite animation into the more efficient native code of the underlying processor(s) 110 and provides the managed sprite interface 122 for function calls to the native code.

Although the sprite interface 122, sprite application 124, and tiler application 126 are each illustrated and described as single application programs, each of the sprite interface 122, sprite application 124, and tiler application 126 can be implemented as several component applications distributed to each perform one or more functions in television-based client device 102. Further, although the sprite application 124 and the tiler application 126 are illustrated and described as separate application programs, the sprite application 124 and the tiler application 126 can be implemented together as a single application program in the native code 116.

The sprite interface 122 can be implemented with application program interface(s) (APIs) 128 via which the gaming application 112 can request or initiate sprite animation functions from the sprite application 124. The sprite interface 122 (via the APIs 128) provides an interface to the sprite animation functions available via the sprite application 124. The sprite application 124 can receive a request for a sprite animation function and provide the sprite animation function to the gaming application 112 via the sprite interface 122. A developer of the gaming application 112 can include function calls to the sprite interface APIs 128 to incorporate the sprite animation functions of the sprite application 124.

The sprite application 124 can be implemented to provide collision detection of sprite images, animation of a sprite image, a tiled sprite image to include in a background image, and/or any other sprite animation functions to the gaming application 112 via the sprite interface 122. Alternatively, or in addition, the tiler application 126 is implemented to provide tiling functions for background images of the gaming application 112 via the sprite interface 122 when initiated or requested by the gaming application 112.

The sprite interface 122, sprite application 124, and the tiler application 126 can each be implemented as a class which is a reference type that encapsulates data (constants and fields) and behavior (methods, properties, indexers, events, operators, instance constructors, static constructors, and destructors), and can contain nested types. An example of each is included below.

The Sprite Engine Class (e.g., the sprite application 124) provides solid flicker-free sprite animation in a graphics mode, such as a three-hundred fifty two by two-hundred forty (352×240) graphics mode. This provides for a custom background layer and a list of at least thirty-two (32) sprites with (x,y) motion vectors for each. The Sprite Engine breaks the memory allocated for a main seven-hundred and four by four-hundred eighty (704×480) display screen into four sub-screens, three of which are used. Two of the sub-screens are used ping-pong style where one is onscreen while the other is being updated.

As each frame of an animation is displayed, the background is blitted to the current off-screen buffer and the sprites are composited on top of the background. Then sprite (x,y) positions are updated by their motion vectors and rectangular collision detection is applied to sprites which are flagged as being collidable. The distinction between managed and native functionality is simple, yet flexible so that the managed layer can individually guide sprites on each frame while the fast rendering and processing work of updating positions is done in the native layer.

The Sprite Engine Class includes:
public SpriteEngine( int xLoc, int yLoc, int width, int height, int numSprites ); creates a new Sprite Engine. A rectangular region of the screen is specified as the area in which to display sprites which are clipped to this as they are drawn. This port can be the whole screen, but it may be convenient to prevent sprites from drawing on regions of the screen reserved for scoring, borders, and other information.
public void Draw( ); builds a new screen, flips the pages, updates the sprite (x,y) coordinates, and returns a collision mask in the public variable EventMask.
public Graphics GetOnscreenGraphics( bool fullScreen ); gets a graphics context for the currently displayed screen. If fullscreen is true, it returns the entire three-hundred fifty two by two-hundred forty (352×240) region, otherwise just the clipping port sub-region is returned.
public Graphics GetOffscreenGraphics( bool fullScreen ); is similar to GetOnscreenGraphics as above, but returns the off-screen side.
public Graphics GetBackgroundGraphics( bool fullScreen ); is similar to GetOnscreenGraphics as above, but returns the background layer. A developer has control over what is drawn on the background layer and may choose to manage it directly instead of attaching a Tiler.
public void FlipPage( ); provides for directly swapping pages to manually manage all drawing operations.
public Sprite [ ] Sprites; is a read-only property that provides access to the array of sprites to be animated. The size of this array is set when the SpriteEngine is constructed. Zero order of the sprites is implicit where lower indexes in the array are drawn first and therefore at a lower Z order while higher indexes will appear on top.

The Tiler Class (e.g., the tiler application 126) can be implemented independent of the sprite application (Sprite Engine). The Tiler Class provides maintaining a single short array described as the “tile” to be displayed at each location on the screen. The value at each location in the array is used to index into an array of images. The Tiler can then quickly render an entire screen of tiles and perform functions such as side and vertical scrolling of the entire screen in an efficient manner. The Tiler Class can also be implemented to generate other types of backgrounds out of spliced images and generate complex backgrounds for dialog boxes and non-gaming user interfaces.

The Tiler Class includes:

public Tiler(

int numTiles,
int cellWidth,
int cellHeight,
int mapCols,
int mapRows,
int visibleCols,
int visibleRows,
Graphics graphics,
short [ ] map );

which constructs a tiler sprite image and describes both the size of the onscreen viewpoint and the overall map size. It is passed a graphics context to draw onto, and the map to use.
public int MapX is a read-only property that returns a current horizontal scroll position of the map.
public int MapY is a read-only property that returns a current vertical position of the map.
public MemoryHandle [ ] Tiles; is a property that provides access to a pre-allocated array which will hold the MemoryHandles to the tile image data. The tile images are loaded into the array prior to drawing. A null simply causes the tile rendering to skip that cell in the grid.
public void Draw(int x, int y); draws the visible portion of the map starting at pixel (x,y) in map space.
public void ScrollHorizontal( int delta ); scrolls the map horizontally by any even number (attempting to scroll past the edge of the screen will result in an exception).
public void ScrollVertical( int delta ); scrolls the map vertically by any even number (attempting to scroll past the edge of the screen will result in an exception).
public void Update( int col, int row, int numCols, int numRows ); draws a sub-region of the map and is used when changing a value in the map array or changing an image tile.

The Tiler can also be “attached” to an optional SpriteEngine via the public variable SpriteEngine. Then when the Tiler scrolls in a given direction it can quickly update the coordinates of the sprites. This saves the managed layer considerable processing work on each scroll.

The Sprite Class (e.g., the managed sprite interface 122). A sprite can be represented by an array of images that are cycled through to create an animation effect, a size, an (x,y) location, and a motion vector that includes (dx,dy) and a step count. An attribute mask can be utilized to describe a sprite as a “hero” (item to test for collisions against) or “collidable”. This moves a portion of the sprite maintenance to the native layer without overly complicating the native drawing engine.

The Sprite Class includes:
public Sprite( int width, int height, int frameCount ); creates a new Sprite declaring it's width and height, and specifying a number of frames that will be provided for animation. The width and height typically should match the width and height of the images supplied, but that is not a hard requirement. The width and height can be used for rectangle-based collision detection. The rendering adheres to the actual width and height information carried in the headers of the BLT images (any image format can be used, but for rendering performance, BLTs are used.)
public int CurrentFrame; can be used to read or write the current frame being displayed.
public int X; specifies an “X” location of the upper left corner of a sprite image.
public int Y; specifies a “Y” location of the upper left corner of a sprite image.
public int Dx; specifies the number of pixels to move a sprite on each Draw( ) operation. After the sprite is drawn at the current location, the “X” location of the sprite will be incremented by this amount. Collision detection can occur on the newly calculated coordinates of all the sprites.
public int Dy; specifies the number of pixels to move a sprite on each Draw( ) operation. After the sprite is drawn at the current location, the “Y” location of the sprite will be incremented by this amount. Collision detection can occur on the newly calculated coordinates of all the sprites.
public int Steps; specifies how many steps to animate the sprite using the Dx,Dy values. If this is zero, the motion vectors are not applied and the sprite is stationary.
public SpriteMode Mode; specifies whether the sprite is a “Hero” (a sprite which cares about colliding with other sprites) or “Collidable” (a sprite which can collide with a “Hero”). If neither of these flags is set, the sprite will not be tested for collision.
public int CollidedWith; provides that if a sprite has collided with another sprite, this will contain the slot in the Sprites

[ ]array of the highest zero ordered sprite involved in the collision.
public MemoryHandle [ ] Frames; is read-only property that exposes an array containing the frames of image data for the sprite.
public int Width; is a read-only property that returns the width assigned to a sprite at construction time.
public int Height; is a read-only property that returns the height assigned to a sprite at construction time.

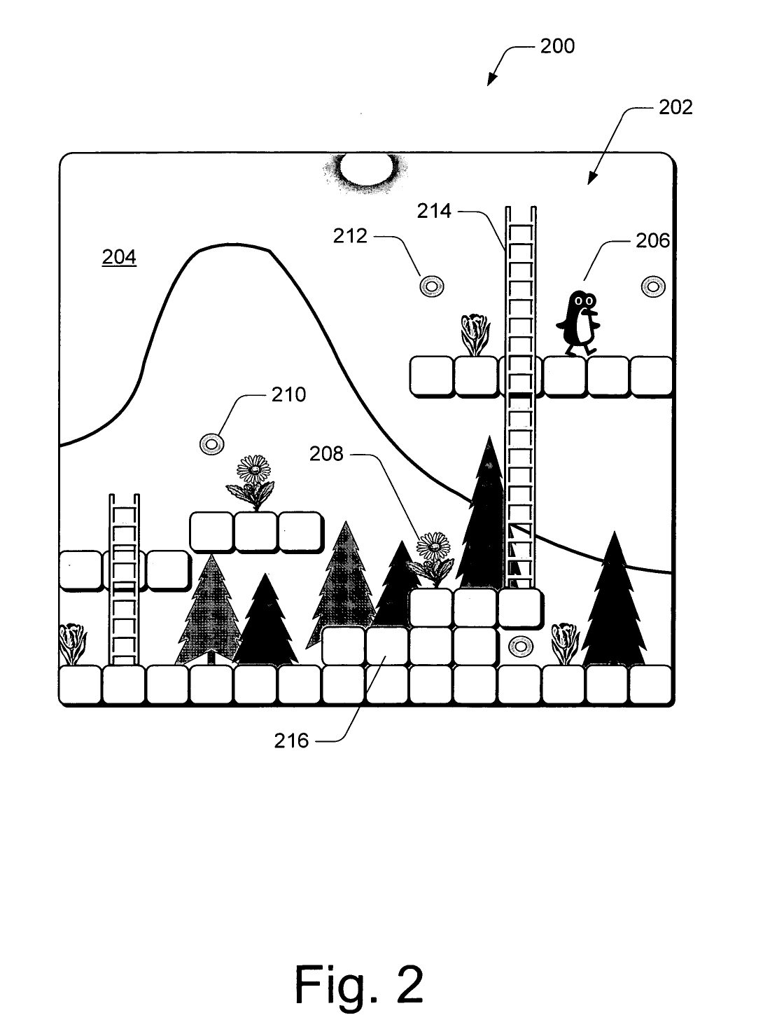

FIG. 2 illustrates an example 200 of Sprite animation and tiling which can be implemented with the exemplary gaming system 100 shown in FIG. 1. A gaming display 202 is an example of the interactive display 118 displayed on display device 104. The gaming display 202 includes a background 204, an animated sprite character 206, and various tiled sprite images such as flower 208, game pieces 210 and 212, ladder 214, and a block 216. In operation, the gaming application 112 provides the background 204 of the gaming display 202 (to include the mountain, trees, and sun in this example).

The gaming application 112 incorporates the animated sprite character 206 and the various tiled sprite images via the managed sprite interface 122 which interfaces to the native code 116 where the sprite application 124 and/or the tiler application 126 provides the sprite engine functions of tiling, sprite animation, and collision detection. In the example 200, the animated sprite character moves from one location to the next over the blocks (e.g., block 216) and to different block levels while superimposed over the ladders (e.g., ladder 214) to obtain the game pieces (e.g., game pieces 210 and 212) which is determined as a “collision” between sprite images.

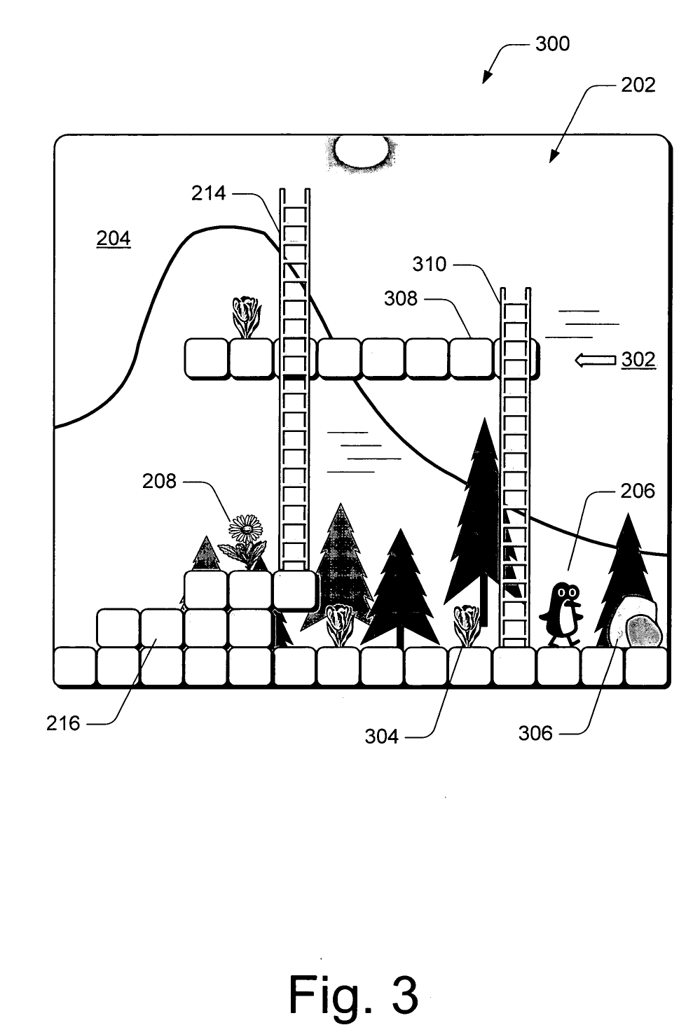

FIG. 3 further illustrates an example 300 of the Sprite animation and tiling example 200 shown in FIG. 2. As illustrated, the gaming display 202 still includes the background 204 of the mountain, trees, and sun all in the same position as shown in FIG. 2. The animated sprite character 206 has moved from the position shown in FIG. 2, and as the character moves toward the left side of the display 202, the various tiled sprite images move to the right in a direction indicated by arrow 302 such that the animated sprite character 206 visually appears to be moving left and off of the display screen. For example, the flower 208, the ladder 214, and the block 216 have all been moved to the left across the gaming display 202 (as compared to their respective positions shown in FIG. 2), thus providing the visual effect of the animated sprite character 206 moving to the right across the gaming display 202. The example 300 also includes additional tiled sprite images such as flower 304, rocks 306, block 308, and ladder 310 which come into view as the animated sprite character 206 moves to the right across the gaming display 202.

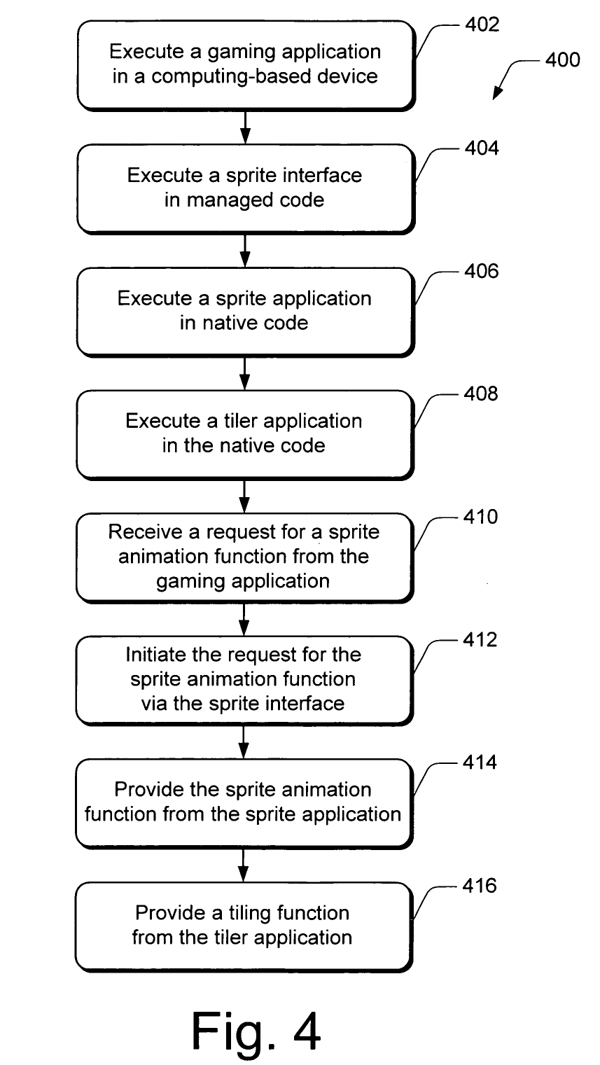

Methods for Sprite interface and code-based functions, such as exemplary method 400 described with reference to FIG. 4, may be described in the general context of computer executable instructions. Generally, computer executable instructions can include routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

FIG. 4 illustrates an exemplary method 400 for Sprite interface and code-based functions and is described with reference to the exemplary gaming system shown in FIG. 1. The order in which the method is described is not intended to be construed as a limitation, and any number of the described method blocks can be combined in any order to implement the method, or an alternate method. Furthermore, the method can be implemented in any suitable hardware, software, firmware, or combination thereof

At block 402, a gaming application is executed in a computing-based device, such as a low-end television-based client device. For example, the processor(s) 110 in client device 102 execute and process gaming application 112 from which an interactive gaming display 118 is displayed on display device 104 for user interaction via the remote control device 106 or game controller 108.

At block 404, a sprite interface is executed in managed code. At block 406, a sprite application is executed in native code, and at block 408, a tiler application is executed in the native code. For example, the processor(s) 110 in client device 102 execute the managed code 114 which includes the sprite interface 122, and execute the native code 116 which includes the sprite application 124 and the tiler application 126.

At block 410, a request is received for a sprite animation function from the gaming application. At block 412, the request for the sprite animation function is initiated via the sprite interface. For example, the gaming application 112 can initiate or request a sprite animation function via the APIs 128 of the managed sprite interface 122.

At block 414, the sprite animation function is provided from the sprite application, where the sprite animation function is provided to the gaming application via the sprite interface. For example, the sprite application 124 in native code 116 in client device 102 provides any one or more of collision detection between sprite images, animation of a sprite image, and various tiled sprite images for a background image of the gaming application 112 via the Sprite interface 122.

At block 416, a tiling function is provided with the tiler application. For example, and as an alternative to the sprite application 124, the tiler application 126 in native code 116 in client device 102 provides tiling functions for the gaming application 112 via the sprite interface 122.

FIG. 5 illustrates various components of an exemplary client device 500 which can be implemented as any form of a computing, electronic, gaming, and/or television-based client device, and in which embodiments of Sprite interface and code-based functions can be implemented. For example, the client device 500 can be implemented as the television-based client device 102 shown in FIG. 1.

Client device 500 includes one or more media content inputs 502 which may include Internet Protocol (IP) inputs over which streams of media content are received via an IP-based network. Device 500 further includes communication interface(s) 504 which can be implemented as any one or more of a serial and/or parallel interface, a wireless interface, any type of network interface, a modem, and as any other type of communication interface. A wireless interface enables client device 500 to receive control input commands 506 and other information from an input device, such as from remote control device 508, PDA (personal digital assistant) 510, cellular phone 512, or from another infrared (IR), 802.11, Bluetooth, or similar RF input device.

A network interface provides a connection between the client device 500 and a communication network by which other electronic and computing devices can communicate data with device 500. Similarly, a serial and/or parallel interface provides for data communication directly between client device 500 and the other electronic or computing devices. A modem facilitates client device 500 communication with other electronic and computing devices via a conventional telephone line, a DSL connection, cable, and/or other type of connection.

Client device 500 also includes one or more processors 514 (e.g., any of microprocessors, controllers, and the like) which process various computer executable instructions to control the operation of device 500, to communicate with other electronic and computing devices, and to implement embodiments of Sprite interface and code-based functions. Client device 500 can be implemented with computer readable media 516, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer readable media 516 provides data storage mechanisms to store various information and/or data such as software applications and any other types of information and data related to operational aspects of client device 500. For example, an operating system 518 and/or other application programs 520 can be maintained as software applications with the computer readable media 516 and executed on processor(s) 514 to implement embodiments of Sprite interface and code-based functions.

For example, client device 500 can be implemented to include a program guide application 522 that is implemented to process program guide data 524 and generate program guides for display which enable a viewer to navigate through an onscreen display and locate broadcast programs, recorded programs, video on-demand programs and movies, interactive game selections, network-based applications, and other media access information or content of interest to the viewer. The application programs 520 can include programmed application(s) to implement features and embodiments of Sprite interface and code-based functions as described herein, such as any one or more of the gaming application 112, sprite interface 122, sprite application 124, and tiler application 126 shown in FIG. 1. Alternatively, a programmed application can be implemented as an integrated module or component of the program guide application 522. The client device 500 can also include a DVR system 526 with playback application 528, and recording media 530 to maintain recorded media content 532.

The client device 500 also includes an audio and/or video output 534 that provides audio and video to an audio rendering and/or display system 536, or to other devices that process, display, and/or otherwise render audio, video, and image data. Video signals and audio signals can be communicated from device 500 to a television 538 (or to other types of display devices) via an RF (radio frequency) link, S-video link, composite video link, component video link, analog audio connection, or other similar communication link.

Although embodiments of Sprite interface and code-based functions have been described in language specific to structural features and/or methods, it is to be understood that the subject of the appended claims is not necessarily limited to the specific features or methods described. Rather, the specific features and methods are disclosed as exemplary implementations of Sprite interface and code-based functions.

1. A system, comprising:
a sprite interface configured to provide an interface to sprite animation functions for a gaming application; and
a sprite application implemented in native code and configured to provide the sprite animation functions via the sprite interface when initiated by the gaming application.

2. A system as recited in claim 1, wherein the sprite interface is a managed sprite interface implemented in managed code.

3. A system as recited in claim 1, further comprising a television-based client device configured to execute the gaming application, the sprite interface, and the sprite application.

4. A system as recited in claim 1, wherein the sprite application is further configured to provide collision detection of sprite images to the gaming application via the sprite interface.

5. A system as recited in claim 1, wherein the sprite application is further configured to provide an animated sprite image to the gaming application via the sprite interface.

6. A system as recited in claim 1, wherein the Sprite application is further configured to provide a tiled sprite image for a background image of the gaming application via the sprite interface.

7. A system as recited in claim 1, further comprising a tiler application implemented in the native code and configured to provide tiling functions via the sprite interface when initiated by the gaming application.

8. A system as recited in claim 1, further comprising a tiler application implemented in the native code and configured to provide tiling functions for a background image of the gaming application via the sprite interface, and wherein the sprite application is further configured to provide an animated sprite image superimposed over a tiled sprite image to the gaming application via the sprite interface.

9. A method, comprising:
receiving a request for a sprite animation function from an application;
initiating the request for the sprite animation function via a sprite interface; and
providing the sprite animation function from a sprite application implemented in native code, the sprite animation function being provided to the application via the sprite interface.

10. A method as recited in claim 9, further comprising executing the application as a gaming application in a television-based client device.

11. A method as recited in claim 10, further comprising executing the sprite interface in managed code and executing the sprite application in the native code in the television-based client device.

12. A method as recited in claim 9, wherein providing the sprite animation function includes providing collision detection of sprite images to the application via the sprite interface.

13. A method as recited in claim 9, wherein providing the sprite animation function includes providing animation of a sprite image to the application via the sprite interface.

14. A method as recited in claim 9, wherein providing the sprite animation function includes providing a tiled sprite image for a background image of the application via the sprite interface.

15. A method as recited in claim 9, further comprising providing a tiling function with a tiler application implemented in the native code, the tiling function being provided to the application via the sprite interface.

16. One or more computer readable media comprising computer executable instructions that, when executed, direct a television-based client device to:
execute a gaming application;
instantiate a sprite interface executed as managed code to receive a request for a sprite animation function from the gaming application; and
execute a sprite application as native code to provide the sprite animation function to the gaming application via the sprite interface.

17. One or more computer readable media as recited in claim 16, further comprising computer executable instructions that, when executed, direct the television-based client device to instantiate a tiler application executed as native code to provide a tiling function to the gaming application via the sprite interface.

18. One or more computer readable media as recited in claim 16, further comprising computer executable instructions that, when executed, direct the television-based client device to execute the sprite application to provide collision detection of sprite images to the gaming application via the sprite interface.

19. One or more computer readable media as recited in claim 16, further comprising computer executable instructions that, when executed, direct the television-based client device to execute the sprite application to provide an animated sprite image to the gaming application via the sprite interface.

20. One or more computer readable media as recited in claim 16, further comprising computer executable instructions that, when executed, direct the television-based client device to execute the sprite application to provide a tiled sprite image for a background image of the gaming application via the sprite interface.
